(19) United States
(12) Patent Application Publication
(10) Pub. No.: US 2026/0238714 A1
(43) Pub. Date: Aug. 13, 2026

(54) System and Methods for Context-based Wireless Communication

(71) Applicant: BlackBerry Limited, Waterloo (CA)

(72) Inventors: Achyuth Wayne NANDIKOTKUR, Kitchener (CA); Glenn Daniel WURSTER, Kitchener (CA)

(21) Appl. No.: 19/051,104

(22) Filed: Feb. 11, 2025

(51) Int. Cl. H04M 1/72454; H04W 76/10

(52) U.S. Cl. CPC H04M 1/72454; H04W 76/10; H04M 2201/42

(57) ABSTRACT

A method of context-based wireless communication. The method comprises receiving an input by a user equipment (UE) to initiate communication to a destination device, wherein the UE comprises a radio transceiver and a processor; determining by the UE that a context associated with the destination device is unfavorable to communication; after determining that the context associated with the destination device is unfavorable to communication, monitoring by the UE the context associated with the destination device; in response to determining that the context associated with the destination device has changed from being unfavorable to communication to being favorable to communication, presenting by the UE a selection option to initiate the communication with the destination device; and in response to receiving an input activating the selection option to initiate the communication with the destination device, initiating by the UE communication via the radio transceiver with the destination device.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Wireless communication permits users to communicate via a number of different technical communication mechanisms at almost any location and at any time. Using a smart phone, for example, a user can originate a voice call to a destination device, send a text message to a destination device, or send an email to a destination device. Some remote locations may have sparse or no wireless coverage from cell towers, but such areas are the exception, and for most users for most of the time, their smart phone is in wireless communication coverage.

### SUMMARY

In an embodiment, a user equipment (UE) is disclosed. The UE comprises an antenna; a radio transceiver communicatively coupled to the antenna; a non-transitory memory; a processor communicatively coupled to the radio transceiver and to the non-transitory memory; and a communication application, stored in the non-transitory memory. When executed by the processor, the communication application receives an input to initiate communication from the UE to a destination device, determines that a context associated with the destination device is unfavorable to communication, presents a message on the UE about the context associated with the destination device, presents a first selection option to defer initiating communication with the destination device until the context associated with the destination device is favorable to communication, and presents a second selection option to initiate communication with the destination device notwithstanding the context associated with the destination device that is unfavorable to communication. The communication application, when executed, further receives an input activating the first selection option, in response to receiving the input activating the first selection option, monitors the context associated with the destination device, in response to determining that the context associated with the destination device has changed from unfavorable to communication to favorable to communication, presents a message on the UE about the context associated with the destination device being favorable to communication and presents a selection option to initiate the communication with the destination device, and in response to receiving an input activating the selection option to initiate the communication with the destination device, initiates communication via the radio transceiver with the destination UE.

In another embodiment, a method of context-based wireless communication is disclosed. The method comprises receiving an input by a user equipment (UE) to initiate communication to a destination device, wherein the UE comprises a radio transceiver and a processor; determining by the UE that a context associated with the destination device is unfavorable to communication; after determining that the context associated with the destination device is unfavorable to communication, monitoring by the UE the context associated with the destination device; in response to determining that the context associated with the destination device has changed from being unfavorable to communication to being favorable to communication, presenting by the UE a selection option to initiate the communication with the destination device; and in response to receiving an input activating the selection option to initiate the communication with the destination device, initiating by the UE communication via the radio transceiver with the destination device.

In yet another embodiment, a method of context-based wireless communication is disclosed. The method comprises receiving an input by a user equipment (UE) to initiate communication to a destination device, wherein the UE comprises a radio transceiver and a processor; retrieving a context associated with the destination device and a context indexed communication preference associated with the destination device; and determining by the UE, based on the context associated with the destination device and the context indexed communication preference associated with the destination device, that a user associated with the destination device is not favorable to receiving a communication from the UE. The method further comprises, after determining that the user associated with the destination device is not favorable to receive the communication from the UE, monitoring by the UE the context associated with the destination device; in response to determining that the context associated with the destination device has changed to a context in which the user associated with the destination device is favorable to receiving the communication from the UE, presenting by the UE a selection option to initiate the communication with the destination device; and in response to receiving an input activating the selection option to initiate the communication with the destination device, initiating by the UE communication via the radio transceiver with the destination device.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a system according to an embodiment of the disclosure.

FIG. 2 is a block diagram of a set of context-indexed communication preferences according to an embodiment of the disclosure.

FIG. 3 is a flowchart of a method according to an embodiment of the disclosure.

FIG. 4 is a flowchart of another method according to an embodiment of the disclosure.

FIG. 5 is a flowchart of yet another method according to an embodiment of the disclosure.

FIG. 6 is a flowchart of yet another method according to an embodiment of the disclosure.

FIG. 7 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Mobile communication devices support our communicating easily with others at any and all times. The ease of initiating electronic communication may lead us to intrude upon or interrupt others when we initiate our communication with them. The other person, out of politeness, may go ahead and receive our communication, even when it is inconvenient and causes disruption to their activity. The present disclosure teaches a system and methods of sharing a context of another person before initiating communication with them, whereby to avoid intruding unnecessarily upon their ongoing activity.

A context of a called party can be defined and shared with a user equipment (UE) on the event of, or immediately prior to, initiation of an electronic communication to the called party. A communication application executing on the UE can take this shared context into consideration when attempting to initiate the electronic communication. If the called party is in a context that is favorable to receiving the communication, the communication application can originate the communication. If, however, the called party is in a context that is unfavorable to receiving the communication, the communication application may reject the attempt to originate the communication, for example presenting a message on a display screen of the UE that the called party is indisposed to receive the communication at the current time. Alternatively, if the called party is in an unfavorable context, the communication application may present a message indicating the called party is indisposed to receive the communication while also presenting a selection input to initiate the communication notwithstanding. In an emergency situation, the user of the UE desiring to initiate communication with the called party may want to initiate the communication notwithstanding the unfavorable context of the called party.

The present disclosure contemplates context-based management of a plurality of different kinds of electronic communication. The different kinds of electronic communication can include voice calls, text messages, video calls, emails, TCP/IP packets, SIP messages, and other kinds of electronic communication. Different contexts of called parties can include driving, sleeping, exercising, at work, at leisure, eating, and other contexts. In an embodiment, a set of context indexed communication preferences can be defined for a communication device, and this set of preferences can be distributed to a calling UE. In an embodiment, a context indexed communication preferences data structure can associate a given context to a preference for each different communication type. For example, a driving context may associate to a preference to not receive voice calls and a preference to not receive text messages. An eating context may associate to a preference to not receive voice calls and a preference to receive text messages. Different individuals may define different preferences. A first individual may prefer to not receive voice calls when eating; a second individual may prefer to receive voice calls when eating (i.e., to not avoid receiving voice calls while eating).

Each different potential called party can define his or her own context indexed communication preferences data structure using their communication device. The context indexed communication preferences data structures may be stored in a data store. A context server application executing on a computer may receive requests for a specific context indexed communication preferences data structure on the event of a communication application on a UE attempting to initiate a communication and return the context indexed communication preferences data structure to the requesting communication application. Alternatively, the context server application on the computer may receive a request for a public encryption key associated with the called party from the UE of the calling party, the context server application may return the public encryption key to the UE of the calling party, and the UE of the calling party may request the encrypted context and the encrypted context indexed communication preferences data structure from the called party. The called party may retrieve the calling party public encryption key from the context server application and use it to encrypt context and the encrypted context indexed communication preferences data structure. The UE of the calling party may use the calling party key to decrypt the encrypted context indexed communication preference data structure of the called party, and the communication application on the UE of the calling party may manage communication with the called party based on a current context of the called party and based on the context indexed communication data structure of the called party.

In an embodiment, the contacts application on a UE may maintain information on the context of communication devices and/or persons known to the contacts application. For example, the contacts application on the UE may periodically poll the current context of each of the contacts stored in the contacts application. Alternatively, the communication devices may periodically push their current context out to UEs that have registered with them to receive context updates. Alternatively, communication devices may push their current context to a context server application executing on a computer, and each of a plurality of UEs can poll the context server application for current contexts of communication devices listed in its contacts application. In an embodiment, the propagation of context from a communication device to the context server application or to the UEs contacts applications may be event driven: on the event of a change of context of a given communication device, the new context is propagated and is deemed to remain the current context of the communication device until the next change of context pushes a new context.

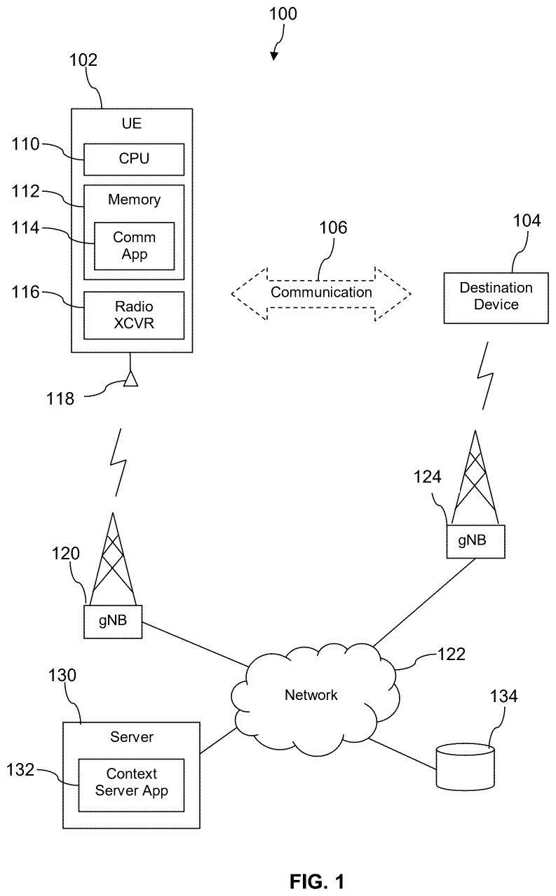

Turning now to FIG. 1, a system 100 is described. In an embodiment, the system 100 comprises a user equipment (UE) 102 and a destination device 104. The UE 102 may desire to establish a communication 106 with the destination device 104. The UE 102 may be referred to as a calling party, and the destination device 104 may be referred to as a called party. While it is understood that a first human user is associated with the UE 102 and a second human user is associated with the destination device 104, and that the first human user desires to communicate with the second human user, the descriptions herein will focus on the UE 102 and the destination device 104 and mostly leave the human users out of the discussion. In an embodiment, the UE 102 may be a mobile phone, a smart phone, a VoIP phone, a soft phone, a personal digital assistant, a wearable computer, a headset computer, a personal computer, a laptop computer, a tablet computer, or a notebook computer. The destination device 104 may be a mobile phone, a VoIP phone, a soft phone, a smart phone, a personal digital assistant, a wearable computer, a headset computer, a personal computer, a laptop computer, a tablet computer, or a notebook computer. While FIG. 1 illustrates a single UE 102 and a single destination device 104, it is understood that the system 100 may comprise any number of UEs 102 and any number of destination devices 104. Additionally, at least some of the UEs 102 of the system 100 may act in the role or destination devices 104.

To establish the abstract communication 106 illustrated by the dashed-line arrow, the UE 102 may establish a wireless communication link with a first cell site 120, the first cell site 120 may be communicatively linked to a network 122, the network 122 may be communicatively linked to a second cell site 124, and the second cell site 124 may establish a wireless communication link with the destination device 104. Alternatively, a wireless access point (AP) may be communicatively linked to the network 122, and the AP may establish a wireless communication link with the destination device 104. Alternatively, the network 122 may establish a wired communication link with the destination device 104. Also alternatively, the UE 102 may establish a wired communication link with the network 120. In an embodiment, the system 100 may comprise any number of cell sites 120, 124.

The UE 102 may comprise a processor (CPU) 110, a memory 112, a communication application 114 stored in a non-transitory portion of the memory 112, a radio transceiver 116, and an antenna 118. The radio transceiver 116 and the antenna 118 may establish a wireless communication link with the first cell site 120 according to a 5G, a 6G, a long-term evolution (LTE), a code division multiple access (CDMA), a global system for mobile communication (GSM), a wired (e.g., ethernet, plain old telephone service (POTS)), or fiber-optic telecommunication protocol. In an embodiment, the destination device 104 may have a structure similar to the UE 102. The network 122 comprises one or more private networks, one or more public networks, or a combination thereof. The communication 106 between the UE 102 and the destination device 104 may be a voice call, a text message, a video call, an email, or some other kind of communication.

Under some conditions or contexts, the destination device 104 (e.g., the user associated with the destination device 104) may desire to not be disturbed. For example, while sharing dinner with a spouse, the user of the destination device 104 may prefer not to receive any communication whatsoever. This may be referred to as the user of the destination device 104 being unfavorable to receiving any communications via the destination device 104, while in this context (e.g., while sharing dinner with a spouse). Alternatively, while sharing dinner with a spouse, the user of the destination device 104 may be unfavorable to receiving a voice call but is favorable to receiving a text message-which the user can read quickly and either reply to or defer replying to until after dinner is over. These attitudes of a user of the destination device 104 as to what kinds of communication he or she may be favorable towards or unfavorable towards in different contexts may be referred to as context-based communication preferences.

In an embodiment, the system 100 comprises a computer 130 that executes a context server application 132 and references a data store 134. The data store 134 may contain a plurality of context indexed communication preference data structures. The context server application 132 may provide a variety of services to the UE 102 to support context-based wireless communication by the UE 102. As used herein, context-based wireless communication means communication that takes into account, one way or another, the current context of a called party, for example, the current context of the user associated with the destination device 104. Taking the context of the user associated with the destination device 104 into account can include at least making the UE 102 and/or the user associated with the UE 102 (e.g., the calling party) aware of the current context of the destination device 104. The UE 102 and/or the user associated with the UE 102 may disregard the current context of the destination device 104 and/or the user of the destination device 104, as in the case of an emergency, but the UE 102 and/or user associated with the UE 102 is at least aware of the context of the destination device 104.

In an embodiment, a communication application 114 executing on the destination device 104 is able to determine the context of the user of the destination device 104 and make that context available to the UE 102. For example, the destination device 104 may associate a location of the destination device 104 with a particular context. Being at a first location (the location of a gym) may be associated with an exercising context. Being at a second location (the location in a restaurant district of a city) may be associated with an eating context. Being at a third location (the location of a running part) may be associated with a running context. Being at a fourth location (the location of an office building) may be associated with a working context. A circumstance in which the location of the destination device 104 is changing rapidly may be associated with a driving context. Context can be inferred by the communication application 114 in other ways. A step counter contained in the destination device 104 can be used to infer the context that the user is running or walking. A Bluetooth connection to a cycling computer can be used to infer the context that the user is cycling. Data received from a health monitor attached to the destination device 104 can be used to infer additional exercise or stress related factors of context. The user of the destination device 104 may use an editor of the communication application 114 to define rules that map to different contexts. In an embodiment, the communication application 114 may automatically synthesize rules for inferring context.

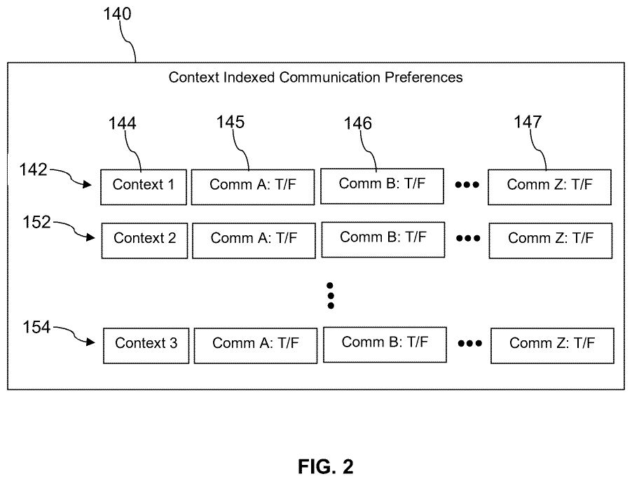

Turning now to FIG. 2, a context indexed communication preferences data structure 140 is described. The context indexed communication preferences data structure 140 may be referred to simply as the preferences 140 in some context herein. The preferences 140 comprises a first context indexed set of preferences 142, a second context indexed set of preferences 152, and a third context indexed set of preferences 154. Each of the context indexed set of preferences 142, 152, 154 is associated with a different context. Each context indexed set of preferences 142, 152, 154 identifies a plurality of communication preferences associated with the subject context. For example, the first context indexed set of preferences 142 comprises a context index 144, a context indexed preference for a first communication type 145, a context indexed preference for a second communication type 146, and a context indexed preference for a third communication type 147. A context index preference for a communication type may be a true/false value, a yes/no value, a 1/0 value, or some other value. In general, one value of the context index preference for the communication type indicates that, in the subject context, the concerned user is either favorable to receiving the given communication type or is unfavorable to receiving the given communication type. A communication type 145 may be any combination of methods of communication (e.g., phone call, text message, email, TCP/IP packets and/or messages) and of subject of communication (e.g., work related, social related).

While context indexed preferences for three different communication types are illustrated in FIG. 2, it is understood that the preferences 140 may define context indexed preferences for any number of different communication types. In an embodiment, the context indexed preference for the first communication type 145 may be a context indexed preference for all voice calls; the context indexed preference for the second communication type 146 may be a context indexed preference for text messages about current news events, and the context indexed preference for the third communication type 147 may be a context indexed preference for all personal communication. The context index 144 of the first context indexed set of preferences 142 may be a driving context; the context index of the second context indexed set of preferences 152 may be an eating context, the context index of the third context indexed set of preferences 154 may be a sleeping context. It will be appreciated that the preferences 140 may comprise any number of context indexed set of preferences. For example, other context indexed set of preferences can have a working context index, an at leisure context index, an exercising context index, a special interest meeting context index, and other contexts.

It is understood that different users and/or different UEs 102 and different destination devices 104 can define different preferences 140, and these different preferences may be stored in data store 134. Alternatively, the different preferences 140 can be stored in each UE 102 and/or each destination device 104. It is understood that the users can change their preferences 140 at different times and cause their updated preferences 140 to be visible to UEs 102 and/or destination devices 104. The context indexed communication preferences data structure 140 may take a variety of different forms.

In an embodiment, the context indexed communication preferences data structure may take the form of an Extensible Markup Language (XML) file, a serialized object, a proprietary data format, a yet another markup language (YAML) file, or a JavaScript Object Notation (JSON) file. For example, a simple context indexed communication preferences JSON could look like:

```
{
  “user_preferences”: [
    {
      “condition”: “at_leisure”,
      “calls”: true,
      “texts”: true
    },
    {
      “condition”: “at work”,
      “subject”: “personal”,
      “texts”: false,
      “email”: false
    },
    {
      “condition”: “at work”,
      “calls”: true,
      “texts”: true
    },
    {
      “condition”: “driving”,
      “calls”: false,
      “texts”: false
    },
    {
      “condition”: “sleeping”,
      “calls”: false,
      “texts”: false
    },
    {
      “condition”: “running”,
      “calls”: false,
      “texts”: true
    },
    {
      “condition”: “hiking”,
      “calls”: true,
      “texts”: true
    },
    {
      “condition”: “at_court_house”,
      “heart_rate”: {
        “comparison”: “>”,
        “value”: 100
      }
      “calls”: false,
      “texts”: false
    }
  ]
}
```

This example set of preferences could be interpreted by the communication application 114 to indicate that the destination device 104 is favorable to receiving voice calls and texts when in the at leisure context, is not favorable to receiving personal texts and emails while in the work context, is favorable to receiving other voice calls and texts when in the at work context, is unfavorable to receiving either voice calls or texts when in the driving context, is unfavorable to receiving either voice calls or texts when in the sleeping context, is unfavorable to receiving voice calls but is favorable to receiving texts when in the running context, is favorable to receiving both voice calls and texts when in the hiking context, and is unfavorable to receiving either voice calls or texts when in a context of being at the court house and having a heartbeat that exceeds 100 beats per minute.

The user of the destination device 104 associated with this example set of preferences may be a public prosecutor who may experience high levels of physical stress (e.g., increased heartbeat rate) while appearing in a courtroom before a judge at a court house. When this condition is met (at the court house, and heartbeat rate over 100 beats per minute), the user of the destination device 104 may be unfavorable to receiving any communication via his or her destination device 104. The user may have a wearable device that monitors his or her heartbeat rate and this information may be shared with the destination device 104. The destination device 104 may provide access to this heartbeat rate as part of the context of the destination device 104. In an alternative implementation, the destination device 104 may provide a service that allows the UE 102 to query the state of the user of the destination device 104 without providing descriptions of the state. In such an embodiment, the condition may be an index and the court house example preference may appear as follows:

```
{
  “condition”: 8,
  “calls”: false,
  “texts”: false
}
```

It will be appreciated that different destination devices 104 (e.g., different users of different destination devices 104) can define different context indexed communication preferences data structures 140. It is understood that the same destination device 104 can change its context indexed communication preferences data structure 140 at any time, and that these changes would naturally flow through the system 100 and be adapted to within a suitable time lag (e.g., with a time lag of less than a minute, less than five minutes, less than ten minutes, less than fifteen minutes, less than an hour, or less than twenty-four hours). The user of the destination device 104 may use a preferences editor provided on the destination device 104 (for example, provided by the communication application 114 installed on the destination device 104) to define these preferences. The preferences editor may then process these inputs to generate the context indexed communications preferences data structure 140, for example the JSON file described above.

As another example, the above example JSON could have the “at_work” preferences defined instead as follows:

```
{
  “condition”: “at_work”,
  “time_range”: [
    {start”: “2025-12-01 10:30 EST”,
    “end”: “2025-12-01 11:00 EST”},
  ],
  “calls”: false
  “texts”: false
},
{
  “condition”: “at_work”,
  “calls”: true,
  “texts”: true
}
```

This variation of the preferences indicates that on Dec. 1, 2025, from 10:30 am to 11:00 am EST, when the user is at work, the destination device 104 is unfavorable to receiving either voice calls or texts. Outside of this time window, when the user is at work, the destination device 104 is favorable to receiving both voice calls and texts. It will be appreciated that this simple example of preferences can be expanded in a variety of ways to provide finely grained and subtle expressions of context-based communication preferences. For example, only two different kinds of communication—voice calls and texts—are indicated. This JSON file implementation can easily be expanded to include preference definitions for other communication types such as emails and video calls. Likewise, this JSON file implementation can easily be expanded to include subjects and other contexts. It is understood that different users can define different contexts. For example, a second user may not distinguish between hiking and running and may provide only an exercising context. A third user may have a context defined for being engaged in a bluegrass jam session.

With reference now to FIG. 1 and FIG. 2, if the UE 102 starts a process to establish voice communication with the destination device 104, for example, the user of the UE 102 opens its phone call application and/or selects a contacts display, the current context of the destination device 104 may be determined, the preferences 140 of the destination device 104 may be obtained, and the current context of the destination device 104 may be used to index into the preferences 140 of the destination device 104. The UE 102 will learn what the preference of the destination device 104 is, given its current context, for receiving a voice call (because the UE 102 is attempting to establish a voice communication with the destination device 104), and act accordingly.

Suppose the current context is that the user of the destination device 104 is at leisure, and that while in the “at leisure” context, the destination device 104 (the user of the destination device) is favorable to receiving all communication types. This means that the destination device 104 is favorable to receiving a voice call, and the UE 102 goes ahead and originates a voice call to the destination device 104, the call connects, and the user of the UE 102 and the user of the destination device 104 have a voice-based conversation.

At a later time, the user of the destination device 104 may be driving when the UE 102 starts the process of initiating another voice call to the destination device 104. Suppose that in this “driving” context the destination device 104 (the user of the destination device) is unfavorable to receiving a voice call communication. In this case, the UE 102 may present a notification (e.g., on a display screen of the UE 102) indicating that the destination device 104 is not currently favorable to receiving a voice call. In this case, the attempt by the UE 102 to initiate a voice call may be automatically terminated. In an embodiment, the UE 102 may present the notification that the destination device 104 is not currently favorable to receiving a voice call but presents an input control for initiating the voice call notwithstanding that the destination device 104 is unfavorable towards receiving voice calls at the present time, possibly because the UE 102 wants to communicate information related to an urgent matter or emergency to the destination device 104.

In an embodiment, the UE 102 may present an input control for the communication application 114 to begin periodically polling the context of the destination device 104, determining when the context changes to favorable to receiving a voice call communication, and presenting a notification on that event that the destination device 104 is now favorable to receive a voice call communication and presenting a control input for initiating the voice call. In this way, the user of the UE 102 need not self-prompt to retry initiating a voice call communication with the destination device 104, perhaps forgetting to try again or perhaps trying repeatedly and repeatedly finding the context of the destination device 104 had not changed. The UE 102 and/or the communication application 114 can automatically monitor the context of the destination device 104, making the experience of the user of the UE 102 more convenient and less prone to frustration.

In an embodiment, the UE 102 may present a notification indicating the destination device 104 is not currently favorable to receiving a voice call and also indicating that the destination device 104 is currently favorable to receiving a text message (e.g., the text message may be presented through a hands-free user interface by the vehicle the user of the destination device 104 is driving—perhaps where the destination device 104 is communicatively paired with a telematics unit of the vehicle; or the text message may simply be stored on the destination device 104 for future reading). The UE 102 may present a control that can be selected to compose a text message directed to the destination device 104.

In an embodiment, the UE 102 may present a notification indicating the destination device 104 is not currently favorable to receiving a text message, presenting a control input for sending the text message when the destination device 104 becomes favorable to receive a text message. In this way, the user of the UE 102 need not retry sending a text message to the destination device 104 at a later point in time. The UE 102 and/or the communication application 114 can automatically monitor the context of the destination device 104, sending the text message when the destination device 104 is in a favorable state or context.

The context-based wireless communication described above may be performed, at least in part, by the communication application 114—for example, a voice calling communication application, a texting communication application, a video communication application, a messaging application, or other communication application. In an embodiment, each different communication application 114 may embed separately the context-based communication functions described above. In an embodiment, the context-based wireless communication described above may be performed, at least in part, by a contacts application of the UE 102, for example wherein the contacts application presents a list of different users and provides inputs for selecting one or more communication types to communicate with the subject users. In an embodiment, the context-based wireless communication functionality described above may be performed, at least in part, by an operating system of the UE 102.

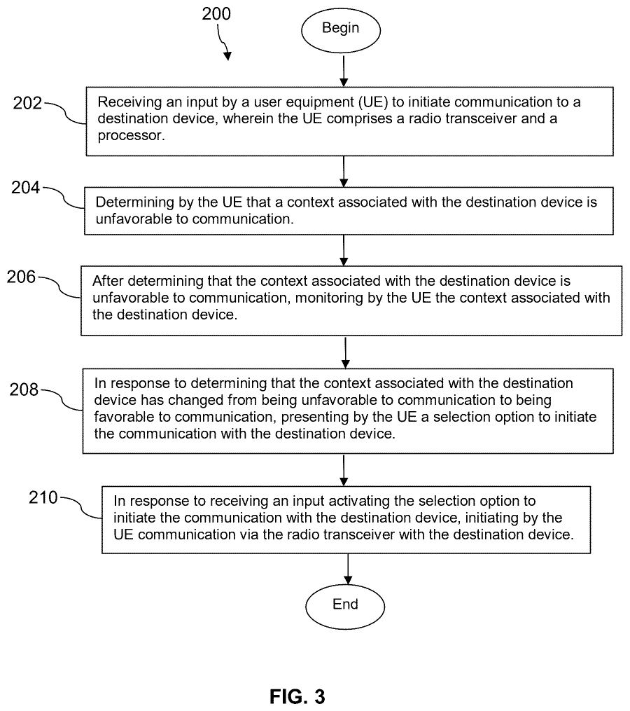

Turning now to FIG. 3, a method 200 is described. In an embodiment, the method 200 is a method of context-based wireless communication. At block 202, the method 200 comprises receiving an input by a user equipment (UE) to initiate communication to a destination device, wherein the UE comprises a radio transceiver and a processor.

At block 204, the method 200 comprises determining by the UE that a context associated with the destination device is unfavorable to communication. In an embodiment, the context associated with the destination device is one of an at leisure context, a driving context, a sleeping context, a working context, an exercising context, or an eating context. In an embodiment, determining that the context associated with the destination device is unfavorable to communication comprises requesting the context of the destination device from the destination device. In an embodiment, determining that the context associated with the destination device is unfavorable to communication comprises using a context of the destination device to index into a context indexed communication preferences data structure associated with the destination device, wherein the context indexed communication preferences data structure indicates a user favorability or unfavorability to receiving communication for each of a plurality of different contexts. In an embodiment, the context indexed communication preferences data structure indicates, for each of a plurality of different contexts, user favorability or unfavorability to receiving each of a plurality of different communication types. In an embodiment, part of the processing of block 204 comprises requesting the context of the destination device from a context server application executing on a computer. At block 206, the method 200 comprises, after determining that the context associated with the destination device is unfavorable to communication, monitoring by the UE the context associated with the destination device. In an embodiment, monitoring by the UE the context associated with the destination device comprises periodically polling the context of the destination device.

At block 208, the method 200 comprises, in response to determining that the context associated with the destination device has changed from being unfavorable to communication to being favorable to communication, presenting by the UE a selection option to initiate the communication with the destination device. At block 210, the method 200 comprises, in response to receiving an input activating the selection option to initiate the communication with the destination device, initiating by the UE communication via the radio transceiver with the destination device.

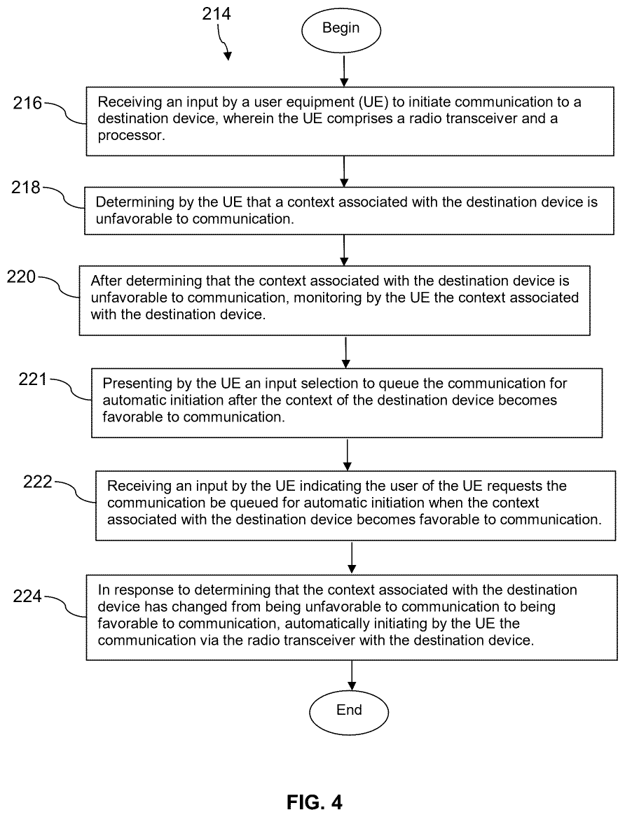

Turning now to FIG. 4, a method 214 is described. In an embodiment, the method 214 is a method of context-based wireless communication. At block 216, the method 214 comprises receiving an input by a user equipment (UE) to initiate communication to a destination device, wherein the UE comprises a radio transceiver and a processor.

At block 218, the method 214 comprises determining by the UE that a context associated with the destination device is unfavorable to communication. In an embodiment, the context associated with the destination device is one of an at leisure context, a driving context, a sleeping context, a working context, an exercising context, or an eating context. In an embodiment, determining that the context associated with the destination device is unfavorable to communication comprises requesting the context of the destination device from the destination device. In an embodiment, determining that the context associated with the destination device is unfavorable to communication comprises using a context of the destination device to index into a context indexed communication preferences data structure associated with the destination device, wherein the context indexed communication preferences data structure indicates a user favorability or unfavorability to receiving communication for each of a plurality of different contexts. In an embodiment, the context indexed communication preferences data structure indicates, for each of a plurality of different contexts, user favorability or unfavorability to receiving each of a plurality of different communication types. In an embodiment, part of the processing of block 218 comprises requesting the context of the destination device from a context server application executing on a computer. At block 220, the method 214 comprises, after determining that the context associated with the destination device is unfavorable to communication, monitoring by the UE the context associated with the destination device. In an embodiment, monitoring by the UE the context associated with the destination device comprises periodically polling the context of the destination device.

At block 221, the method 214 comprises presenting by the UE an input selection to queue the communication for automatic initiation after the context of the destination device becomes favorable to communication. At block 222, the method 214 comprises receiving an input by the UE indicating the user of the UE requests the communication be queued for automatic initiation when the context associated with the destination device becomes favorable to communication. At block 224, the method 214 comprises, in response to determining that the context associated with the destination device has changed from being unfavorable to communication to being favorable to communication, automatically initiating by the UE the communication via the radio transceiver with the destination device.

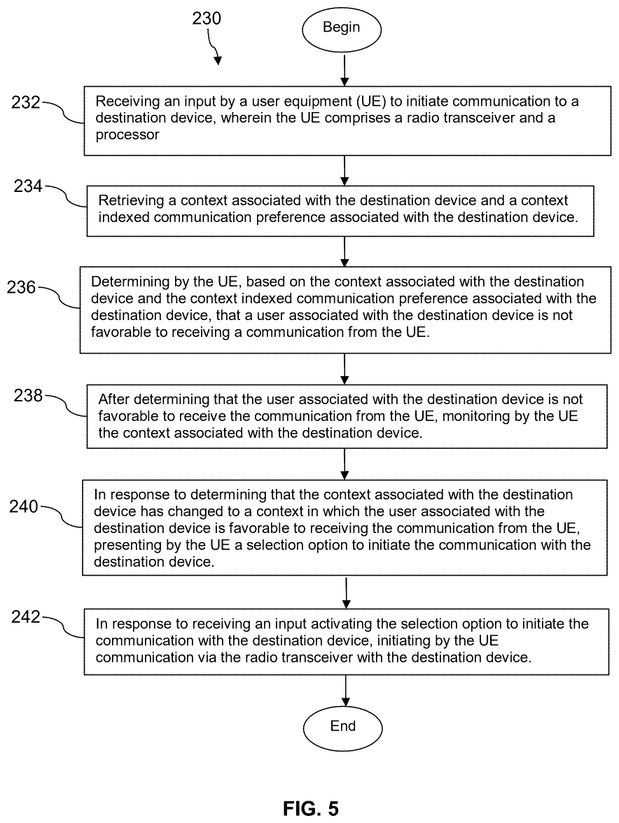

Turning now to FIG. 5, a method 230 is described. In an embodiment, the method 230 is a method of context-based wireless communication. At block 232, the method 230 comprises receiving an input by a user equipment (UE) to initiate communication to a destination device, wherein the UE comprises a radio transceiver and a processor. In an embodiment, the UE is one of a smart phone, a personal digital assistant, a wearable computer, a headset computer, a laptop computer, a notebook computer, or a tablet computer.

At block 234, the method 230 comprises retrieving a context associated with the destination device and a context indexed communication preference associated with the destination device. At block 236, the method 230 comprises determining by the UE, based on the context associated with the destination device and the context indexed communication preference associated with the destination device, that a user associated with the destination device is not favorable to receiving a communication from the UE.

At block 238, the method 230 comprises, after determining that the user associated with the destination device is not favorable to receive the communication from the UE, monitoring by the UE the context associated with the destination device. In an embodiment, monitoring by the UE the context associated with the destination device comprises polling the context of the destination device periodically by the UE. In an embodiment, the UE polls the context of the destination device at a periodic rate that depends on the context of the destination device. For example, the UE may poll the context of the destination device at a higher rate if the context is exercising and poll the context of the destination device at a lower rate if the context is sleeping or working. In an embodiment, the context indexed communication preferences data structure 140 may indicate a recommended polling rate associated with each different context. In another embodiment, the destination device may push a context change, which the UE receives instead of having to poll the destination device.

At block 240, the method 230 comprises, in response to determining that the context associated with the destination device has changed to a context in which the user associated with the destination device is favorable to receiving the communication from the UE, presenting by the UE a selection option to initiate the communication with the destination device. In an embodiment, determining that the context associated with the destination device is unfavorable to communication and determining that the context associated with the destination device has changed from being unfavorable to communication to being favorable to communication comprises decrypting a context indication. For example, the UE may request the context and preferences of the destination device from the destination device. The destination device may send the context and preferences to the UE in an encrypted form. The UE may decrypt the encrypted context and preferences using a private encryption key associated with the public key that the destination device used to encrypt the context and preferences. In another embodiment, the encrypted content and preferences may be decrypted using a key shared between the UE and the destination device.

At block 242, the method 230 comprises, in response to receiving an input activating the selection option to initiate the communication with the destination device, initiating by the UE communication via the radio transceiver with the destination device. In an embodiment, determining by the UE, based on the context associated with the destination device and the context indexed communication preference associated with the destination device, that the user associated with the destination device is not favorable to receiving the communication from the UE comprises using a context of the destination device to index into a context indexed communication preferences data structure associated with the destination device, wherein the context indexed communication preferences data structure indicates a user favorability or unfavorability to receiving communication for each of a plurality of different contexts.

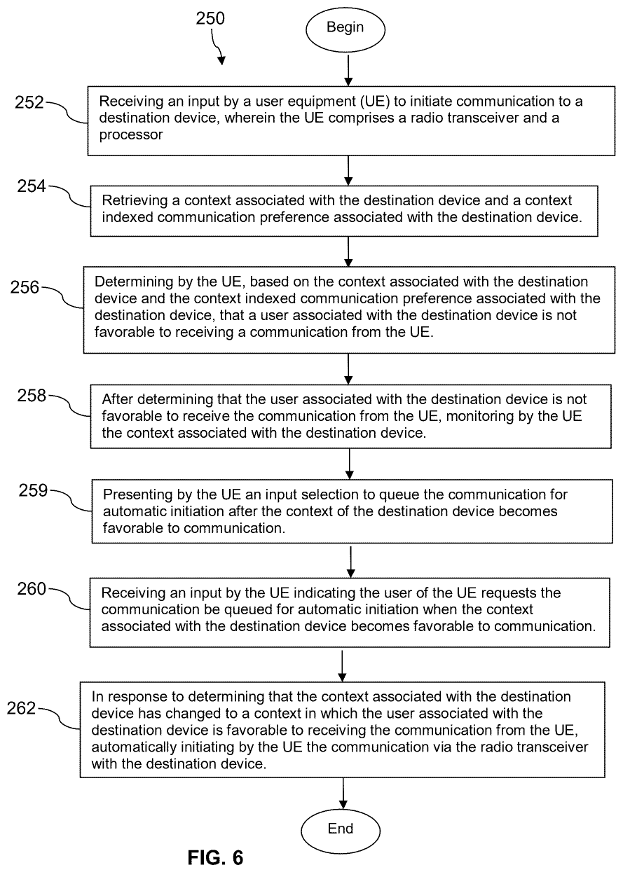

Turning now to FIG. 6, a method 250 is described. In an embodiment, the method 250 is a method of context-based wireless communication. At block 252, the method 250 comprises receiving an input by a user equipment (UE) to initiate communication to a destination device, wherein the UE comprises a radio transceiver and a processor. In an embodiment, the UE is one of a smart phone, a personal digital assistant, a wearable computer, a headset computer, a laptop computer, a notebook computer, or a tablet computer.

At block 254, the method 250 comprises retrieving a context associated with the destination device and a context indexed communication preference associated with the destination device. At block 256, the method 250 comprises determining by the UE, based on the context associated with the destination device and the context indexed communication preference associated with the destination device, that a user associated with the destination device is not favorable to receiving a communication from the UE.

At block 258, the method 250 comprises, after determining that the user associated with the destination device is not favorable to receive the communication from the UE, monitoring by the UE the context associated with the destination device. In an embodiment, monitoring by the UE the context associated with the destination device comprises polling the context of the destination device periodically by the UE. In an embodiment, the UE polls the context of the destination device at a periodic rate that depends on the context of the destination device. For example, the UE may poll the context of the destination device at a higher rate if the context is exercising and poll the context of the destination device at a lower rate if the context is sleeping or working. In an embodiment, the context indexed communication preferences data structure 140 may indicate a recommended polling rate associated with each different context. In another embodiment, the destination device may push a context change, which the UE receives instead of having to poll the destination device.

At block 259, the method 250 comprises presenting by the UE an input selection to queue the communication for automatic initiation after the context of the destination device becomes favorable to communication. At block 260, the method 250 comprises receiving an input by the UE indicating the user of the UE requests the communication be queued for automatic initiation when the context associated with the destination device becomes favorable to communication. At block 262, the method 260 comprises, in response to determining that the context associated with the destination device has changed to a context in which the user associated with the destination device is favorable to receiving the communication from the UE, automatically initiating by the UE the communication via the radio transceiver with the destination device.

In an embodiment, determining that the context associated with the destination device is unfavorable to communication and determining that the context associated with the destination device has changed from being unfavorable to communication to being favorable to communication comprises decrypting a context indication. For example, the UE may request the context and preferences of the destination device from the destination device. The destination device may send the context and preferences to the UE in an encrypted form. The UE may decrypt the encrypted context and preferences using a private encryption key associated with the public key that the destination device used to encrypt the context and preferences. In another embodiment, the encrypted content and preferences may be decrypted using a key shared between the UE and the destination device. In an embodiment, determining by the UE, based on the context associated with the destination device and the context indexed communication preference associated with the destination device, that the user associated with the destination device is not favorable to receiving the communication from the UE comprises using a context of the destination device to index into a context indexed communication preferences data structure associated with the destination device, wherein the context indexed communication preferences data structure indicates a user favorability or unfavorability to receiving communication for each of a plurality of different contexts.

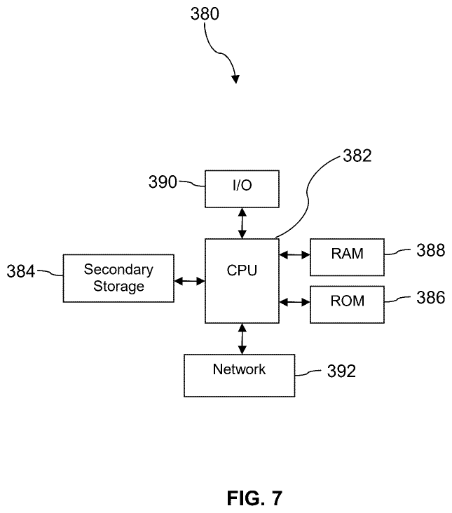

FIG. 7 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or flash chips and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A user equipment (UE), comprising:
an antenna;
a radio transceiver communicatively coupled to the antenna;
a non-transitory memory;
a processor communicatively coupled to the radio transceiver and to the non-transitory memory; and
a communication application, stored in the non-transitory memory, that when executed by the processor:
receives an input to initiate communication from the UE to a destination device,
determines that a context associated with the destination device is unfavorable to communication,
presents a message on the UE about the context associated with the destination device,
presents a first selection option to defer initiating communication with the destination device until the context associated with the destination device is favorable to communication,
presents a second selection option to initiate communication with the destination device notwithstanding the context associated with the destination device that is unfavorable to communication,
receives an input activating the first selection option,
in response to receiving the input activating the first selection option, monitors the context associated with the destination device,
in response to determining that the context associated with the destination device has changed from the unfavorable to communication to favorable to communication, presents a message on the UE about the context associated with the destination device being favorable to communication and presents a selection option to initiate the communication with the destination device, and
in response to receiving an input activating the selection option to initiate the communication with the destination device, initiates communication via the radio transceiver with the destination UE.

2. The UE of claim 1, wherein the context associated with the destination device comprises one of a sleeping context, a working context, an eating context, a driving context, an exercising context, or an at leisure context.

3. The UE of claim 1, wherein the UE is one of a VoIP phone, a soft phone, a smart phone, a personal digital assistant, a wearable computer, a headset computer, a laptop computer, a notebook computer, or a tablet computer.

4. The UE of claim 1, wherein the radio transceiver is configured to establish wireless communication via the antenna according to a 5G, a 6G, a long-term evolution (LTE), a code division multiple access (CDMA), or a global system for mobile communications (GSM) telecommunication protocol.

5. The UE of claim 1, wherein the communication application is a contacts application.

6. The UE of claim 1, wherein the communication application is a voice calling application.

7. The UE of claim 1, wherein the communication application is a video communication application or a messaging application.

8. A method of context-based wireless communication, comprising:
receiving an input by a user equipment (UE) to initiate communication to a destination device, wherein the UE comprises a radio transceiver and a processor;
determining by the UE that a context associated with the destination device is unfavorable to communication;
after determining that the context associated with the destination device is unfavorable to communication, monitoring by the UE the context associated with the destination device;
in response to determining that the context associated with the destination device has changed from being unfavorable to communication to being favorable to communication, presenting by the UE a selection option to initiate the communication with the destination device; and
in response to receiving an input activating the selection option to initiate the communication with the destination device, initiating by the UE communication via the radio transceiver with the destination device.

9. The method of claim 8, wherein the monitoring by the UE the context associated with the destination device comprises periodically polling the context of the destination device.

10. The method of claim 8, wherein determining that the context associated with the destination device is unfavorable to communication comprises requesting the context of the destination device from the destination device.

11. The method of claim 8, wherein determining that the context associated with the destination device is unfavorable to communication comprises requesting the context of the destination device from a context server application executing on a computer.

12. The method of claim 8, wherein determining that the context associated with the destination device is unfavorable to communication comprises using a context of the destination device to index into a context indexed communication preferences data structure associated with the destination device, wherein the context indexed communication preferences data structure indicates a user favorability or unfavorability to receiving communication for each of a plurality of different contexts.

13. The method of claim 12, wherein the context indexed communication preferences data structure indicates, for each of a plurality of different contexts, user favorability or unfavorability to receiving each of a plurality of different communication types.

14. The method of claim 8, wherein the context is one of an at leisure context, a driving context, a sleeping context, a working context, an exercising context, or an eating context.

15. A method of context-based wireless communication, comprising:
receiving an input by a user equipment (UE) to initiate communication to a destination device, wherein the UE comprises a radio transceiver and a processor;
retrieving a context associated with the destination device and a context indexed communication preference associated with the destination device;
determining by the UE, based on the context associated with the destination device and the context indexed communication preference associated with the destination device, that a user associated with the destination device is not favorable to receiving a communication from the UE;
after determining that the user associated with the destination device is not favorable to receive the communication from the UE, monitoring by the UE the context associated with the destination device;
in response to determining that the context associated with the destination device has changed to a context in which the user associated with the destination device is favorable to receiving the communication from the UE, presenting by the UE a selection option to initiate the communication with the destination device; and
in response to receiving an input activating the selection option to initiate the communication with the destination device, initiating by the UE communication via the radio transceiver with the destination device.

16. The method of claim 15, wherein the UE is one of a smart phone, a personal digital assistant, a wearable computer, a headset computer, a laptop computer, a notebook computer, or a tablet computer.

17. The method of claim 15, wherein monitoring by the UE the context associated with the destination device comprises polling the context of the destination device periodically by the UE.

18. The method of claim 17, wherein the UE polls the context of the destination device at a periodic rate that depends on the context of the destination device.

19. The method of claim 15, wherein determining that the context associated with the destination device is unfavorable to communication and determining that the context associated with the destination device has changed from being unfavorable to communication to being favorable to communication comprises decrypting a context indication.

20. The method of claim 15, wherein determining by the UE, based on the context associated with the destination device and the context indexed communication preference associated with the destination device, that the user associated with the destination device is not favorable to receiving the communication from the UE comprises using a context of the destination device to index into a context indexed communication preferences data structure associated with the destination device, wherein the context indexed communication preferences data structure indicates a user favorability or unfavorability to receiving communication for each of a plurality of different contexts.
